(19) United States
(12) Patent Application Publication
(10) Pub. No.: US 2021/0124808 A1
(43) Pub. Date: Apr. 29, 2021

(54) LAYERED FINITE ELEMENT ANALYSIS OF LAMINATED COMPOSITE STRUCTURES

(71) Applicant: Bell Textron Inc., Fort Worth, TX (US)

(72) Inventors: Olivier Blanc, Pointe-Calumet (CA); Swaroop Bylahally Visweswaraiah, Pierrefonds (CA)

(73) Assignee: Bell Textron Inc., Fort Worth, TX (US)

(21) Appl. No.: 16/666,652

(22) Filed: Oct. 29, 2019

(51) Int. Cl. G06F 17/50

(52) U.S. Cl. CPC G06F 17/5018; G06F 2217/16

(57) ABSTRACT

There is provided a method and a system for finite element (FE) analysis of a composite structure comprising plies arranged according to a stacking sequence and layers of bonding agent. Each layer of bonding agent interconnects two adjacent plies. In-plane properties and out-of-plane properties of the composite structure are received. An FE model of the composite structure is generated by representing the plies by two-dimensional (2D) elements configured to be arranged according to the stacking sequence, representing the layers of bonding agent by three-dimensional (3D) elements, each 3D element configured to interconnect two adjacent 2D elements, and associating the in-plane properties with the 2D elements and the out-of-plane properties with the 3D elements. An FE analysis of the FE model is performed to predict delamination of the composite structure.

### TECHNICAL FIELD

The present disclosure relates generally to composite structures, and more specifically to finite element (FE) modeling and analysis of laminated composite structures.

### BACKGROUND OF THE ART

Virtual simulation of structural behavior using numerical methods, such as advanced FE simulation methods, drives cost reduction in design, testing, certification and facilitates reduction in weight and time to market, particularly in the aerospace industry.

A number of FE modeling and analysis methods currently exist for composite structures, which generally consist of a matrix (or resin) that binds high stiffness fibers together as an integral unit. One such method is to model each fiber layer (or ply) in a laminate (or stack of plies) individually layer by layer, following a sequence. Plies are represented by three-dimensional brick-like FE layers attached at nodes. Another method is to model the laminate using a simplified plate-like representation. All the plies in the laminate are mathematically assigned to two-dimensional planar elements. These methods are however confined to in-plane loading conditions and do not capture the resin behaviour in the out-of-plane (or through-the-thickness) direction because perfect bonding between plies is assumed. Hence, existing methods do not provide accurate prediction of delamination of a composite element, i.e. the separation between plies which occurs when the composite element is subjected to a force normal to the plane of the plies. This leads to inefficient and over-conservative structural designs, which in turn results in increased costs and time to market.

Therefore, improvements are needed.

### SUMMARY

In accordance with one aspect, there is provided a computer-implemented method for finite element (FE) analysis of a composite structure, the composite structure comprising a plurality of plies arranged according to a stacking sequence and a plurality of layers of bonding agent, each layer of bonding agent interconnecting two adjacent ones of the plurality of plies. The method comprises receiving in-plane properties and out-of-plane properties of the composite structure, generating an FE model of the composite structure by representing the plurality of plies by a plurality of two-dimensional (2D) elements, the plurality of 2D elements configured to be arranged according to the stacking sequence, representing the plurality of layers of bonding agent by a plurality of three-dimensional (3D) elements, each 3D element configured to interconnect two adjacent ones of the plurality of 2D elements, and associating the in-plane properties with the plurality of 2D elements and the out-of-plane properties with the plurality of 3D elements, and performing an FE analysis of the FE model to predict delamination of the composite structure.

In some embodiments, the plurality of plies is represented by the plurality of 2D elements each having substantially zero thickness and a rectangular shape, and the plurality of layers of bonding agent is represented by the plurality of 3D elements each having a cuboid shape and a predetermined thickness and configured to fill a volume between the two adjacent 2D elements.

In some embodiments, receiving the in-plane properties of the composite structure comprising receiving a longitudinal modulus, a transverse modulus, a shear modulus, a Poisson's ratio in a longitudinal direction of the composite structure, and a Poisson's ratio in a transverse direction of the composite structure.

In some embodiments, the bonding agent is an isotropic resin material provided in the composite structure and receiving the out-of-plane properties of the composite structure comprises receiving a longitudinal modulus, a Poisson's ratio, and a shear modulus for the isotropic resin material.

In some embodiments, the method further comprises receiving a first strain limit for the bonding agent and a second strain limit for the plurality of plies.

In some embodiments, performing the FE analysis of the FE model comprises subjecting the FE model to loading, computing maximum principal stresses in the bonding agent resulting from the FE model being subjected to loading, comparing the maximum principal stresses to the first strain limit, and concluding to failure of the bonding agent upon determining that the maximum principal stresses exceed the first strain limit.

In some embodiments, performing the FE analysis of the FE model to predict delamination of the composite structure comprises subjecting the FE model to loading, computing fiber strains in the plurality of plies resulting from the FE model being subjected to loading, comparing the fiber strains to the second strain limit, and concluding to failure of the plurality of plies upon determining that the fiber strains exceed the second strain limit.

In some embodiments, performing the FE analysis of the FE model comprises subjecting the FE model to loading, determining a first load value at which the FE model fails, and comparing the first load value to a second load value at which the composite structure fails, the second load value obtained upon physically subjecting the composite structure to loading.

In some embodiments, the FE model is generated for the composite structure comprising one of a Tee-joint, a bonded joint, a sandwich-structured composite, an angle ply composite, a joggle, and a complex 3D joint.

In accordance with another aspect, there is provided a system for finite element (FE) analysis of a composite structure, the composite structure comprising a plurality of plies arranged according to a stacking sequence and a plurality of layers of bonding agent, each layer of bonding agent interconnecting two adjacent ones of the plurality of plies. The system comprises at least one processing unit and at least one non-transitory computer-readable memory having stored thereon program instructions executable by the at least one processing unit for receiving in-plane properties and out-of-plane properties of the composite structure, generating an FE model of the composite structure by representing the plurality of plies by a plurality of two-dimensional (2D) elements, the plurality of 2D elements configured to be arranged according to the stacking sequence, representing the plurality of layers of bonding agent by a plurality of three-dimensional (3D) elements, each 3D element configured to interconnect two adjacent ones of the plurality of 2D elements, associating the in-plane properties with the plurality of 2D elements and the out-of-plane properties with the plurality of 3D elements, and performing an FE analysis of the FE model to predict delamination of the composite structure.

In some embodiments, the program instructions are executable by the at least one processing unit for representing the plurality of plies by the plurality of 2D elements each having substantially zero thickness and a rectangular shape, and representing the plurality of layers of bonding agent by the plurality of 3D elements each having a cuboid shape and a predetermined thickness and configured to fill a volume between the two adjacent 2D elements.

In some embodiments, the program instructions are executable by the at least one processing unit for receiving the in-plane properties of the composite structure comprising receiving a longitudinal modulus, a transverse modulus, a shear modulus, a Poisson's ratio in a longitudinal direction of the composite structure, and a Poisson's ratio in a transverse direction of the composite structure.

In some embodiments, the bonding agent is an isotropic resin material provided in the composite structure and the program instructions are executable by the at least one processing unit for receiving the out-of-plane properties of the composite structure comprising receiving a longitudinal modulus, a Poisson's ratio, and a shear modulus for the isotropic resin material.

In some embodiments, the program instructions are further executable by the at least one processing unit for receiving a first strain limit for the bonding agent and a second strain limit for the plurality of plies.

In some embodiments, the program instructions are executable by the at least one processing unit for performing the FE analysis of the FE model comprising subjecting the FE model to loading, computing maximum principal stresses in the bonding agent resulting from the FE model being subjected to loading, comparing the maximum principal stresses to the first strain limit, and concluding to failure of the bonding agent upon determining that the maximum principal stresses exceed the first strain limit.

In some embodiments, the program instructions are executable by the at least one processing unit for performing the FE analysis of the FE model to predict delamination of the composite structure comprising subjecting the FE model to loading, computing fiber strains in the plurality of plies resulting from the FE model being subjected to loading, comparing the fiber strains to the second strain limit, and concluding to failure of the plurality of plies upon determining that the fiber strains exceed the second strain limit.

In some embodiments, the program instructions are executable by the at least one processing unit for performing the FE analysis of the FE model comprising subjecting the FE model to loading, determining a first load value at which the FE model fails, and comparing the first load value to a second load value at which the composite structure fails, the second load value obtained upon physically subjecting the composite structure to loading.

In some embodiments, the program instructions are executable by the at least one processing unit for generating the FE model for the composite structure comprising one of a Tee-joint, a bonded joint, a sandwich-structured composite, an angle ply composite, a joggle, and a complex 3D joint.

In accordance with yet another aspect, there is provided a non-transitory computer readable medium having stored thereon program code executable by at least one processor for receiving in-plane properties and out-of-plane properties of a composite structure comprising a plurality of plies arranged according to a stacking sequence and a plurality of layers of bonding agent, each layer of bonding agent interconnecting two adjacent ones of the plurality of plies, generating an FE model of the composite structure by representing the plurality of plies by a plurality of two-dimensional (2D) elements, the plurality of 2D elements configured to be arranged according to the stacking sequence, representing the plurality of layers of bonding agent by a plurality of three-dimensional (3D) elements, each 3D element configured to interconnect two adjacent ones of the plurality of 2D elements, and associating the in-plane properties with the plurality of 2D elements and the out-of-plane properties with the plurality of 3D elements, and performing an FE analysis of the FE model to predict delamination of the composite structure.

Features of the systems, devices, and methods described herein may be used in various combinations, in accordance with the embodiments described herein.

### BRIEF DESCRIPTION OF THE DRAWINGS

Reference is now made to the accompanying figures in which:

FIG. 1 is a flowchart of a method for FE analysis of composite structures, in accordance with an embodiment;

FIG. 2 is a schematic diagram of a layered FE model of a composite structure, in accordance with an embodiment;

FIG. 3 is a schematic diagram of the composite structure modelled in FIG. 2, in accordance with an embodiment;

FIG. 4 is a schematic diagram of a system for FE analysis of composite structures, in accordance with one embodiment; and

FIG. 5 is a is a block diagram of an example computing device for implementing the method of FIG. 1 and/or the system of FIG. 4, in accordance with one embodiment.

It will be noted that throughout the appended drawings, like features are identified by like reference numerals.

### DETAILED DESCRIPTION

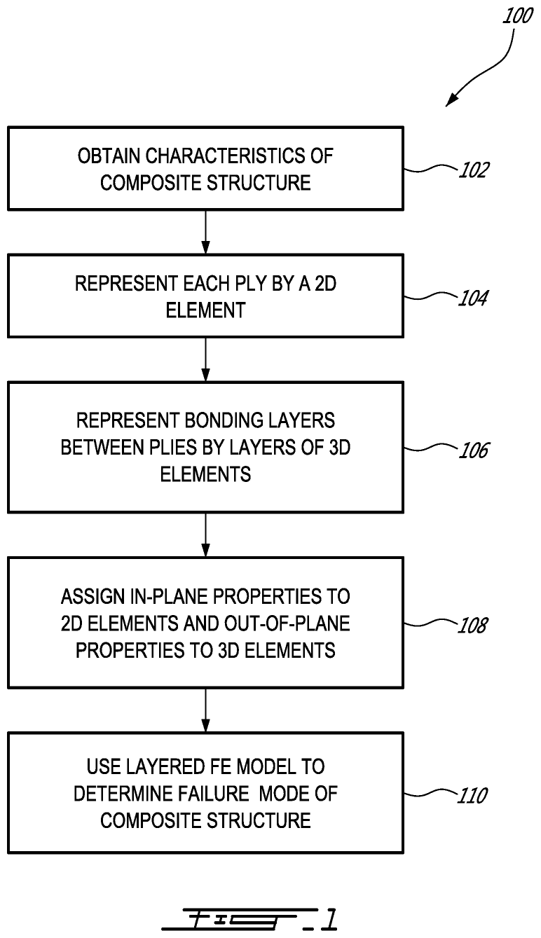

Referring now to FIG. 1, a method 100 for FE analysis of composite structures will now be described. The composite structures referred to herein are illustratively manufactured using a lamination technique where an adhesive or other bonding agent (e.g. an isotropic resin material provided in the composite structure) is used to join multiple layers (also referred to herein as ‘plies’) of high stiffness fibers together as an integral unit. In a particular composite structure, there may be numerous (e.g. tens or hundreds of) plies arranged in a stacking sequence and at least some plies may be made of differing materials. This may result in a laminated composite structure (also referred to as a ‘composite laminate’) that exhibits improved properties including, but not limited to, improve strength, stability, sound insulation, and appearance. Such composite structures may be used for a variety of applications and in a variety of industries including, but not limited to, the aerospace, automotive, medical, and consumer industries.

The methods and systems described herein may be used to predict composite structure failure, namely failure that results in an inability of a composite structure to support loads for which the composite structure was originally designed. In particular, the methods and systems described herein may be used to predict the onset of delamination (also referred to herein as ‘initial delamination’) for a given composite structure. As used herein, delamination refers to the separation between the plies which occurs when the composite structure is subjected to a force that is normal to the plane of the plies of the composite structure. In one embodiment, the systems and methods described herein may allow to predict the initial failure or delamination of composite structures with high accuracy and reliability. The FE modeling and analysis systems and methods described herein may also allow significant reduction in the computational cost associated with modeling laminated composite structures.

The systems and methods described herein may be applied to composite structures having any suitable configuration including, but not limited to, Tee-joints, bonded joints, sandwich-structured composites (i.e. composite materials fabricated by attaching two thin stiff skins to a lightweight thick core), angle-ply composites (i.e. composite laminates with plies oriented at an incline angle), joggles (i.e. joints pre-molded to fit precisely together), and complex three-dimensional (3D) joints. The systems and methods described herein may also be applied to composite structures having any combination of shape, size, and layup as well as to any assembly including, but not limited to, co-cured assemblies, co-bonded assemblies, and bonded panels.

The FE modelling and analysis technique described herein illustratively involves simulating the laminated composite structure and replacing the latter with a virtual representation (referred to herein as a ‘layered FE model’) that behaves substantially identically to the original composite structure. The layered FE model can then be implemented in any suitable FE analysis system. The method 100 may indeed be performed within existing commercially available FE processing software and packages, such as NASTRAN/PATRAN (available from MSC Software Corporation), Altair Hypermesh/Optistruct (available from Altair Engineering, Inc.), NX (Unigraphics) (available from Siemens PLM Software of Plano, Tex.), the ANSYS software suite (Fluent), and the like. The method 100 may alternatively be implemented as bespoke computer software.

The method 100 illustratively comprises obtaining, at step 102, input data indicative of characteristics of a tangible (i.e. real) laminated composite structure comprising at least two plies, each pair of adjacent plies being interconnected by a layer of bonding agent (referred to herein as ‘bonding layer’). The characteristics may be obtained at step 102 by querying a memory, database, or other computer-based storage device in order to retrieve therefrom the input data. In another embodiment, the input data may be received via a user interface including input means (e.g., a touchscreen, mouse, keyboard, and the like) allowing a user to enter the characteristics of the composite structure. In yet another embodiment, a computer-readable input file containing the input data may be received, using any suitable communication means. Other embodiments may apply.

The characteristics obtained at step 102 may comprise a total number of plies of the composite structure to be modelled. The characteristics obtained at step 102 may further comprise physical characteristics obtained by conducting measurement(s) of the composite structure. In one embodiment, the characteristics comprise in-plane and out-of-plane (or through) thickness properties of the composite structure. As used herein, the term ‘in-plane’ refers to forces (or properties) in the plane of a two-dimensional (2D) element while the term ‘out-of-plane’ refers to forces normal (or transverse) to the plane defined by the 2D element. In one embodiment, the in-plane properties include longitudinal (e.g., Young's) modulus (E), transverse modulus, shear modulus (G), Poisson's ratio in a longitudinal direction (of the composite structure), and Poisson's ratio in a transverse direction (of the composite structure). In one embodiment, the out-of-plane properties include longitudinal (e.g., Young's) modulus (E), Poisson's ratio, and shear modulus (G) for the isotropic resin material provided in the composite structure. The out-of-plane properties may be defined using any suitable technique, including, but not limited to, tests, FE comparisons, or Classical Laminate Theory. Allowable bonding agent (e.g., resin) and fiber strain limits for the composite structure may also be obtained at step 102.

Using the input data as obtained at step 102, a layered FE model of the composite structure is generated. The layered FE model represents the composite structure by a mesh of finite elements, including a plurality of 2D and 3D elements. In particular, at step 104, each fiber layer (or ply) of the composite structure is represented by a 2D planar (or ‘plate-like’) element. At step 106, the bonding (e.g., resin) layers between the plies are represented (step 104) by layers of solid 3D cuboid (or ‘brick-like’) elements. Each 3D element interconnects a pair of adjacent 2D planar elements, which are representative of a given pair of plies. At step 108, the in-plane properties of the composite structure are associated with the 2D elements and the out-of-plane properties of the composite structure are associated with the 3D elements. In one embodiment, five (5) in-plane properties (described herein above) are used at step 108 to define the 2D elements and three (3) out-of-plane properties (described herein above) are used to define the 3D elements. The resulting layered FE model may then precisely represent the actual construction of plies in the tangible composite structure.

As understood by those skilled in the art, each ply in the composite structure includes fibers that serve as the primary load-carrying constituent and load transfer between the plies is achieved through the bonding layers. Laminated composite structures generally have adequate strength against tensile, compressive, and in-plane shear loadings but have poor interlaminar properties (i.e. properties between stacked plies), such interlaminar properties being defined by the bonding agent between the plies. In most of the cases, delamination occurs first and failure of the plies (also referred to herein as ‘fiber failure’) occurs consequently. In one embodiment, modelling of the bonding layers between plies of the composite structure may thus allow to precisely represent the bonding agent (e.g., resin), which is prone to delamination before fiber failure occurs, and accordingly accurately predict the onset of a separation of one ply from another.

The layered FE model, which comprises a combination of 2D and 3D elements as described above, may then be used at step 110 to determine a failure mode of the composite structure, and more particularly predict delamination. Step 110 may comprise simulating a behavior of the composite structure as modelled by performing a FE analysis of the layered FE model. In one embodiment, the layered FE model is subjected to loading in order to evaluate one or more factors (or ‘failure indices’) indicative of the failure mode. The one or more failure indices include maximum principal stresses in the resin (modelled by the 3D elements) and fiber strains in the ply (modelled by the 2D elements). If it is determined at step 110 that the maximum principal stresses in the resin exceed resin strain limits, it can be concluded that the resin has failed, i.e. that delamination has occurred. If it is determined at step 110 that the fiber strains exceed allowable strain limits, it can be concluded that failure has occurred in the fibers. The results of the analysis performed at step 110 (i.e. an indication of the failure more of the composite structure) may then be output using any suitable means.

Temperature changes may be taken into account in the layered FE model by adding thermal properties of the bonding agent to the properties of the 3D elements. Step 110 may then comprise assessing whether the bonding agent is undergoing a temperature differentiation. The results of the FE analysis for individual composite plies and individual bonding layers, as modelled, may also be further analyzed to obtain insight into the structural behaviour of the composite structure. For instance, in order to validate the layered FE model, the results of the FE analysis may be compared to results obtained in the physical (i.e. real) world when physically testing the actual composite structure (e.g. subjecting the tangible composite structure to loading). The load value at which the layered FE model fails to perform may be compared to the load value at which the actual composite structure fails (during the physical testing). Any other appropriate analysis on the layered FE model may be performed and results of the FE analysis may be output to any suitable output device (e.g. a computer screen, display, mobile device, or the like), using any suitable communication means, and in any suitable format (e.g., as one or more output files, plots, tables, or the like).

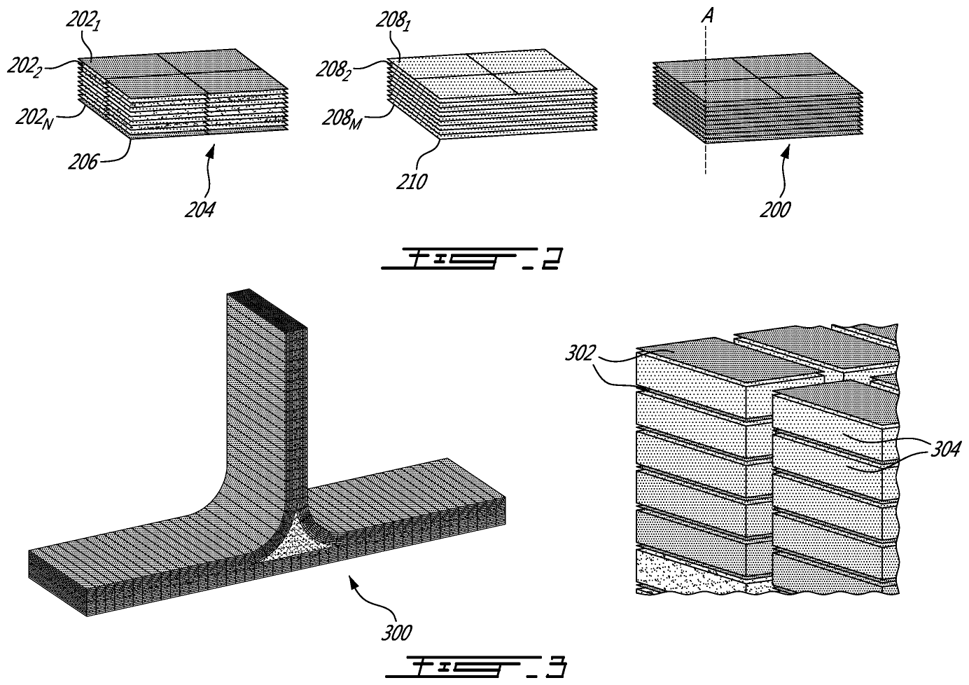

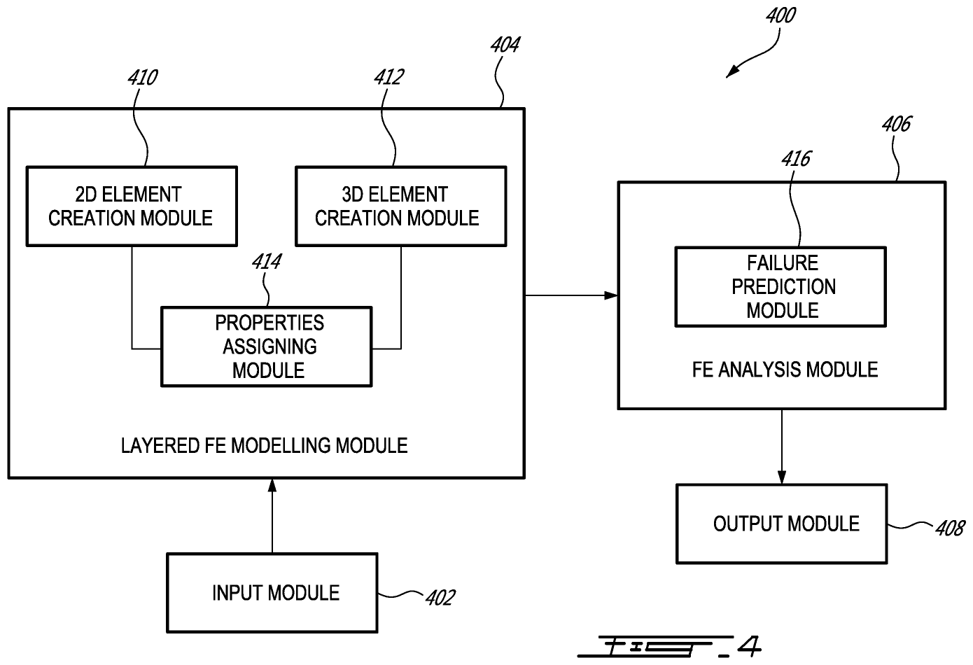

FIG. 2 and FIG. 3 illustrate a layered FE model 200 for a laminated composite structure 300 (illustrated as a Tee-joint) generated by the method 100 of FIG. 1. The layered FE model 200 comprises a number N of spaced 2D elements 202₁, 202₂, . . . , 202_{N}, which are arranged in a stack (or laminate) 204 and each represent a corresponding fiber layer (or ply) 302 of the composite structure 300. Each 2D element 202₁, 202₂, . . . , 202_{N} is quadrilateral (e.g., shaped as a rectangle) and is defined by four (4) distinguishing points (also referred to as nodes) 206, where each node 206 is located at a corner of the 2D element 202₁, 202₂, . . . , 202_{N}. In other words, the geometry of the 2D elements 202₁, 202₂, . . . , 202_{N} is defined by the placement of the nodes 206. The 2D elements 202₁, 202₂, . . . , 202_{N} are flat and have substantially zero physical thickness. The layered FE model 200 also comprises a number M (with M=N−1) of 3D elements 208₁, 208₂, . . . , 208_{M}, each 3D element 208₁, 208₂, . . . , 208_{M} representative of a corresponding bonding (e.g., resin) layer 304 of the composite structure 300. Each 3D element 208₁, 208₂, . . . , 208_{M} is positioned in the gap between a pair of adjacent 2D elements 202₁, 202₂, . . . , 202_{N} and interconnects the pair of 2D elements 202₁, 202₂, . . . , 202_{N} (i.e. the nodes 206 thereof) so as to fill the volume therebetween. Each 3D element 208₁, 208₂, . . . , 208_{N} is shaped as a cuboid and is defined by eight (8) nodes as in 210, where each node 210 is provided at a corner of the 3D element 208₁, 208₂, . . . , 208_{N} such that the geometry of the 3D elements 208₁, 208₂, . . . , 208_{N} is defined by the placement of the nodes 210. Each 3D element 208₁, 208₂, . . . , 208_{N} has a given thickness and a measurable volume. In one embodiment, the corresponding corners (i.e. the nodes 206, 210) of the stacked elements 202₁, 202₂, . . . , 202_{N} and 208₁, 208₂, . . . , 208_{M} are aligned along a same longitudinal direction A, so as to accurately represent the composite structure 300.

Each set of nodes 206, 210 has a nodal dataset associated therewith. The nodal dataset may include values of a property of the composite structure at the respective nodes 206, 210 of the set of nodes 206, 210. As discussed above, in one embodiment, the properties included in the nodal dataset for nodes 206 comprise in-plane properties of the composite structure and the properties included in the nodal dataset for nodes 210 comprise out-of-plane properties of the composite structure.

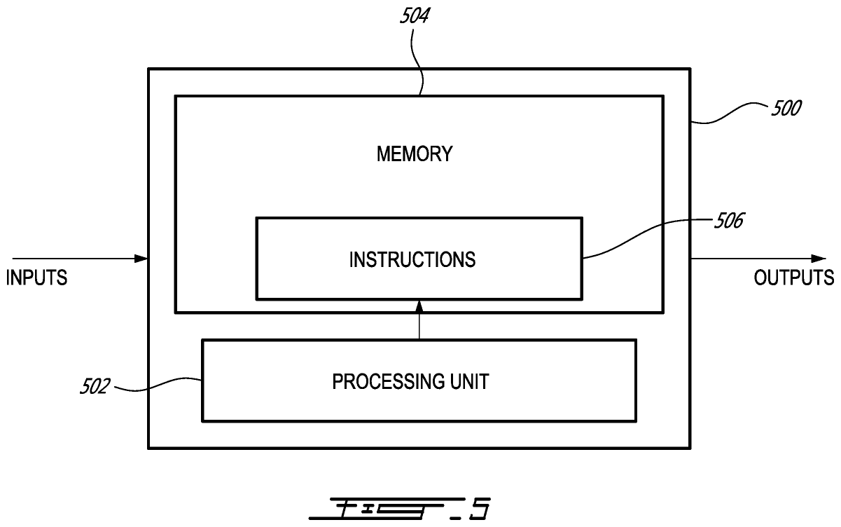

Referring now to FIG. 4, a system 400 for FE analysis of composite structures will now be described. The system 400 is configured to perform a number of functions or operations, as described below, automatically (i.e. without being directly controlled by an operator) and/or under direct operator control. In one embodiment, the system 400 may be implemented as a bespoke system or benefit from one or more commercially-available software tools and packages, as discussed above.

The system 400 illustratively comprises an input module 402, a layered FE modelling module 404, a FE analysis module 406, and an output module 408. The layered FE modelling module 404 comprises a 2D element creation module 410, a 3D element creation module 412, and a properties assigning module 414. The FE analysis module 406 comprises a failure prediction module.

Input data is received at the input module 402. The input data may comprise an identification of the total number of plies of the composite structure to be modelled. The input data may further comprise the in-plane and out-of-plane properties of the composite structure as well as allowable resin and fiber strain limits, as discussed above. The layered FE modelling module 404 may then be configured to obtain the input data from the input module 402 and to accordingly create a FE model of the composite structure (referred to herein as a layered FE model) that comprises a combination of 2D and 3D FE elements. For this purpose, the 2D element creation module 410 is configured to create a number of 2D planar elements, each 2D element being representative of a ply of the composite structure. The 3D element creation module is configured to create a number of 3D elements, each 3D element being representative of a layer of bonding agent (e.g., resin) interconnecting two adjacent plies of the composite structure. Each 3D element is configured to interconnect each pair of adjacent 2D elements so as to fill the volume therebetween.

The properties assigning module 414 is further used to assign the in-plane properties of the composite structure to the 2D elements and to assign the out-of-plane properties of the composite structure to the 3D elements. In one embodiment, the layered FE modelling module 404 is configured to use at least four (4) in-plane properties (as obtained from the input data) in order to define the 2D elements and to use at least two (2) out-of-plane properties (as obtained from the input data) in order to define the 3D elements. In one embodiment, the layered FE modelling module 404 may be configured to compute any additional out-of-plane properties from the original out-of-plane properties obtained from the input data.

The FE analysis module 406 is then configured to analyze the layered FE model generated by the layered FE modelling module 404. In particular, the failure prediction module 416 may be used to predict the initial delamination of the composite structure modelled using the layered FE modelling module 404. For this purpose and as discussed herein above, the failure prediction module 416 may be configured to subject the layered FE model to loading and to evaluate one or more failure indices to determine a failure mode of the composite structure. For example, the failure prediction module 416 may be configured to compute maximum principal stresses in the 3D elements and compare the maximum principal stresses to the resin strain limits (e.g., as obtained from the input data). The failure prediction module 416 can conclude that delamination has occurred if the maximum principal stresses in the resin exceed resin strain limits. The failure prediction module 416 may also be configured to compute fiber strains in the 2D elements and compare the fiber strain to the fiber strain limits (e.g., as obtained from the input data). The failure prediction module 416 can conclude that failure has occurred in the fibers of the composite structure if the fiber strains exceed the allowable strain limits. As discussed above, the FE analysis module 406 may perform any other appropriate analysis on the layered FE model. The output module 408 may then be configured to output the results of the analysis performed by the FE analysis module 406 to a suitable output device, in any suitable format and using any suitable communication means.

FIG. 5 is an example embodiment of a computing device 500 that may be used to implement the systems and methods described herein (e.g. the method 100 and/or at least parts of the system 400). The computing device 500 comprises a processing unit 502 and a memory 504 which has stored therein computer-executable instructions 506. The processing unit 502 may comprise any suitable devices configured to cause a series of steps to be performed such that instructions 506, when executed by the computing device 500 or other programmable apparatus, may cause the functions/acts/steps specified in the methods described herein to be executed. The processing unit 502 (as well as any other processing unit or processor described herein) may comprise, for example, any type of general-purpose microprocessor or microcontroller, a digital signal processing (DSP) processor, a CPU, an integrated circuit, a field programmable gate array (FPGA), a reconfigurable processor, other suitably programmed or programmable logic circuits, or any combination thereof.

The memory 504 may comprise any suitable known or other machine-readable storage medium. The memory 504 may comprise non-transitory computer readable storage medium, for example, but not limited to, an electronic, magnetic, optical, electromagnetic, infrared, or semiconductor system, apparatus, or device, or any suitable combination of the foregoing. The memory 504 may include a suitable combination of any type of computer memory that is located either internally or externally to device, for example random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Memory 504 may comprise any storage means (e.g., devices) suitable for retrievably storing machine-readable instructions 506 executable by processing unit 502.

It should be noted that the present invention can be carried out as a method, can be embodied in a system or on a computer readable medium. The above description is meant to be exemplary only, and one skilled in the art will recognize that changes may be made to the embodiments described without departing from the scope of the invention disclosed. Modifications which fall within the scope of the present invention will be apparent to those skilled in the art, in light of a review of this disclosure, and such modifications are intended to fall within the appended claims.

Various aspects of the systems and methods described herein may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments. Although particular embodiments have been shown and described, it will be apparent to those skilled in the art that changes and modifications may be made without departing from this invention in its broader aspects. The scope of the following claims should not be limited by the embodiments set forth in the examples, but should be given the broadest reasonable interpretation consistent with the description as a whole.

1. A computer-implemented method for finite element (FE) analysis of a composite structure, the composite structure comprising a plurality of plies arranged according to a stacking sequence and a plurality of layers of bonding agent, each layer of bonding agent interconnecting two adjacent ones of the plurality of plies, the method comprising:
receiving in-plane properties and out-of-plane properties of the composite structure;
generating an FE model of the composite structure by:
representing the plurality of plies by a plurality of two-dimensional (2D) elements, the plurality of 2D elements configured to be arranged according to the stacking sequence,
representing the plurality of layers of bonding agent by a plurality of three-dimensional (3D) elements, each 3D element configured to interconnect two adjacent ones of the plurality of 2D elements, and
associating the in-plane properties with the plurality of 2D elements and the out-of-plane properties with the plurality of 3D elements; and
performing an FE analysis of the FE model to predict delamination of the composite structure.

2. The method of claim 1, wherein the plurality of plies is represented by the plurality of 2D elements each having substantially zero thickness and a rectangular shape, and the plurality of layers of bonding agent is represented by the plurality of 3D elements each having a cuboid shape and a predetermined thickness and configured to fill a volume between the two adjacent 2D elements.

3. The method of claim 1, wherein receiving the in-plane properties of the composite structure comprising receiving a longitudinal modulus, a transverse modulus, a shear modulus, a Poisson's ratio in a transverse direction of the composite structure, and a Poisson's ratio in a longitudinal direction of the composite structure.

4. The method of claim 1, wherein the bonding agent is an isotropic resin material provided in the composite structure and receiving the out-of-plane properties of the composite structure comprising receiving a longitudinal modulus, a Poisson's ratio, and a shear modulus for the isotropic resin material.

5. The method of claim 1, further comprising receiving a first strain limit for the bonding agent and a second strain limit for the plurality of plies.

6. The method of claim 5, wherein performing the FE analysis of the FE model comprises:
subjecting the FE model to loading;
computing maximum principal stresses in the bonding agent resulting from the FE model being subjected to loading;
comparing the maximum principal stresses to the first strain limit; and
concluding to failure of the bonding agent upon determining that the maximum principal stresses exceed the first strain limit.

7. The method of claim 5, wherein performing the FE analysis of the FE model to predict delamination of the composite structure comprises:
subjecting the FE model to loading;
computing fiber strains in the plurality of plies resulting from the FE model being subjected to loading;
comparing the fiber strains to the second strain limit; and
concluding to failure of the plurality of plies upon determining that the fiber strains exceed the second strain limit.

8. The method of claim 1, wherein performing the FE analysis of the FE model comprises subjecting the FE model to loading, determining a first load value at which the FE model fails, and comparing the first load value to a second load value at which the composite structure fails, the second load value obtained upon physically subjecting the composite structure to loading.

9. The method of claim 1, wherein the FE model is generated for the composite structure comprising one of a Tee-joint, a bonded joint, a sandwich-structured composite, an angle ply composite, a joggle, and a complex 3D joint.

10. A system for finite element (FE) analysis of a composite structure, the composite structure comprising a plurality of plies arranged according to a stacking sequence and a plurality of layers of bonding agent, each layer of bonding agent interconnecting two adjacent ones of the plurality of plies, the system comprising:
at least one processing unit; and
at least one non-transitory computer-readable memory having stored thereon program instructions executable by the at least one processing unit for:
receiving in-plane properties and out-of-plane properties of the composite structure,
generating an FE model of the composite structure by:
representing the plurality of plies by a plurality of two-dimensional (2D) elements, the plurality of 2D elements configured to be arranged according to the stacking sequence,
representing the plurality of layers of bonding agent by a plurality of three-dimensional (3D) elements, each 3D element configured to interconnect two adjacent ones of the plurality of 2D elements, and
associating the in-plane properties with the plurality of 2D elements and the out-of-plane properties with the plurality of 3D elements, and
performing an FE analysis of the FE model to predict delamination of the composite structure.

11. The system of claim 10, wherein the program instructions are executable by the at least one processing unit for representing the plurality of plies by the plurality of 2D elements each having substantially zero thickness and a rectangular shape, and representing the plurality of layers of bonding agent by the plurality of 3D elements each having a cuboid shape and a predetermined thickness and configured to fill a volume between the two adjacent 2D elements.

12. The system of claim 10, wherein the program instructions are executable by the at least one processing unit for receiving the in-plane properties of the composite structure comprising receiving a longitudinal modulus, a transverse modulus, a shear modulus, a Poisson's ratio in a longitudinal direction of the composite structure, and a Poisson's ratio in a transverse direction of the composite structure.

13. The system of claim 10, wherein the bonding agent is an isotropic resin material provided in the composite structure and the program instructions are executable by the at least one processing unit for receiving the out-of-plane properties of the composite structure comprising receiving a longitudinal modulus, a Poisson's ratio, and a shear modulus for the isotropic material.

14. The system of claim 10, wherein the program instructions are further executable by the at least one processing unit for receiving a first strain limit for the bonding agent and a second strain limit for the plurality of plies.

15. The system of claim 14, wherein the program instructions are executable by the at least one processing unit for performing the FE analysis of the FE model comprising:
subjecting the FE model to loading;
computing maximum principal stresses in the bonding agent resulting from the FE model being subjected to loading;
comparing the maximum principal stresses to the first strain limit; and
concluding to failure of the bonding agent upon determining that the maximum principal stresses exceed the first strain limit.

16. The system of claim 14, wherein the program instructions are executable by the at least one processing unit for performing the FE analysis of the FE model to predict delamination of the composite structure comprising:
subjecting the FE model to loading;
computing fiber strains in the plurality of plies resulting from the FE model being subjected to loading;
comparing the fiber strains to the second strain limit; and
concluding to failure of the plurality of plies upon determining that the fiber strains exceed the second strain limit.

17. The system of claim 10, wherein the program instructions are executable by the at least one processing unit for performing the FE analysis of the FE model comprising subjecting the FE model to loading, determining a first load value at which the FE model fails, and comparing the first load value to a second load value at which the composite structure fails, the second load value obtained upon physically subjecting the composite structure to loading.

18. The system of claim 10, wherein the program instructions are executable by the at least one processing unit for generating the FE model for the composite structure comprising one of a Tee-joint, a bonded joint, a sandwich-structured composite, an angle ply composite, a joggle, and a complex 3D joint.

19. A non-transitory computer readable medium having stored thereon program code executable by at least one processor for:
receiving in-plane properties and out-of-plane properties of a composite structure comprising a plurality of plies arranged according to a stacking sequence and a plurality of layers of bonding agent, each layer of bonding agent interconnecting two adjacent ones of the plurality of plies;
generating an FE model of the composite structure by:
representing the plurality of plies by a plurality of two-dimensional (2D) elements, the plurality of 2D elements configured to be arranged according to the stacking sequence,
representing the plurality of layers of bonding agent by a plurality of three-dimensional (3D) elements, each 3D element configured to interconnect two adjacent ones of the plurality of 2D elements, and
associating the in-plane properties with the plurality of 2D elements and the out-of-plane properties with the plurality of 3D elements; and
performing an FE analysis of the FE model to predict delamination of the composite structure.
